(19) United States
(12) Patent Application Publication
(10) Pub. No.: US 2025/0330890 A1
(43) Pub. Date: Oct. 23, 2025

(54) CONDITIONAL RECONFIGURATION INVOLVING MULTIPLE NETWORK NODES

(71) Applicant: Telefonaktiebolaget LM Ericsson (PUBL), Stockholm (SE)

(72) Inventors: Cecilia Eklöf, TÄBY (SE); Icaro Leonardo Da Silva, SOLNA (SE); Mattias Bergström, Singapore (SG); Liwei Qiu, TÄBY (SE)

(21) Appl. No.: 18/872,140

(22) PCT Filed: May 6, 2023
(86) PCT No.: PCT/SE2023/050446

§ 371 Date: Dec. 5, 2024

Related U.S. Application Data
(60) Provisional application No. 63/365,899, filed on Jun. 6, 2022.

(51) Int. Cl. H04W 36/36; H04W 36/00

(52) U.S. Cl. CPC H04W 36/362; H04W 36/0069

(57) ABSTRACT

According to some embodiments, a method is performed by a network node capable of operating as a source secondary node in a secondary cell group (SCG) for a wireless device operating in dual connectivity with a master node in a master cell group (MCG). The method comprises: configuring the wireless device with one or more configurations for conditional reconfiguration; receiving, from the master node, an indication that the source secondary node shall inform the master node of occurrence of cell change in the secondary cell group; and transmitting, to the master node, an indication of an occurrence of cell change in the secondary cell group for the wireless device.

### TECHNICAL FIELD

Embodiments of the present disclosure are directed to wireless communications and, more particularly, to conditional reconfiguration involving multiple network nodes.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Third Generation Partnership Project (3GPP) specifications include dual connectivity (DC) which enables a user equipment (UE) to be connected in two cell groups, each controlled by a Long Term Evolution (LTE) access node, referred to as the Master eNB, MeNB, and the Secondary eNB, SeNB. The UE only has one radio resource control (RRC) connection with the network. In 3GPP, dual connectivity has evolved and is now also specified for fifth generation (5G) New Radio (NR) as well as between LTE and NR.

Multi-connectivity (MC) refers to a configuration where more than two nodes are involved. With fifth generation (5G) networks, the term MR-DC (Multi-Radio Dual Connectivity, see also 3GPP TS 37.340) is a generic term for all dual connectivity options that include at least one NR access node. Using the MR-DC generalized terminology, the UE is connected in a master cell group (MCG), controlled by the master node (MN), and in a secondary cellGroup (SCG) controlled by a secondary node (SN).

Further, in MR-DC, when dual connectivity is configured for the UE, within each of the two cell groups, MCG and SCG, carrier aggregation may be used as well. In this case, within the MCG controlled by the MN, the UE may use one PCell and one or more SCell(s). Within the SCG controlled by the SN, the UE may use one Primary SCell (PSCell, also referred to as the primary SCG cell in NR) and one or more SCell(s). This combined case is illustrated in FIG. 1.

FIG. 1 is a block diagram illustrating dual connectivity combined with carrier aggregation in MR-DC. As illustrated, the UE is in communication with both the MCG and the SCG. Within each cell group, the UE is in communication with a primary cell and multiple secondary cells.

In NR, the primary cell of a master or secondary cell group may also be referred to as the special cell (SpCell). Thus, the SpCell in the MCG is the PCell and the SpCell in the SCG is the PSCell.

There are different ways to deploy a 5G network with or without interworking with LTE (also referred to as E-UTRA) and evolved packet core (EPC). In principle, NR and LTE may be deployed without any interworking, denoted by NR stand-alone (SA) operation, also referred to as Option 2. A gNB in NR can be connected to 5G core network (5GC) and eNB in LTE can be connected to EPC with no interconnection between the two, also known as Option 1.

On the other hand, the first supported version of NR uses dual connectivity, denoted as EN-DC (E-UTRAN-NR Dual Connectivity), also referred to as Option 3, as depicted in FIG. 2.

FIG. 2 is a block diagram illustrating an example of LTE and NR dual connectivity. In such a deployment, dual connectivity between NR and LTE is applied, where the UE is connected with both the LTE radio interface (LTE Uu in FIG. 2) to an LTE access node and the NR radio interface (NR Uu in FIG. 2) to an NR access node.

Further, in EN-DC, the LTE access node acts as the master node (in this case known as the Master eNB, MeNB), controlling the MCG, and the NR access node acts as the secondary node (in this case sometimes also known as the Secondary gNB, SgNB), controlling the SCG. The SgNB may not have a control plane connection to the core network (EPC) which instead is provided by MeNB and in this case the NR. This is also referred to as “Non-standalone NR” or, in short, “NSA NR”. In this case the functionality of an NR cell is limited and would be used for connected mode UEs as a booster and/or diversity leg, but an RRC_IDLE UE cannot camp on these NR cells.

With introduction of 5GC, other options may be also valid. As mentioned above, Option 2 supports stand-alone NR deployment where gNB is connected to 5GC. Similarly, LTE may also be connected to 5GC using Option 5 (also referred to as eLTE, E-UTRA/5GC, or LTE/5GC, and the node may be referred to as an ng-eNB). In these cases, both NR and LTE are seen as part of the NG-RAN (and both the ng-eNB and the gNB may be referred to as NG-RAN nodes).

There are other variants of dual connectivity between LTE and NR that have been standardized as part of NG-RAN connected to 5GC. The MR-DC umbrella includes the following:
EN-DC (Option 3): LTE is the master node and NR is the secondary node (EPC CN employed, as depicted in FIG. 2)
NE-DC (Option 4): NR is the master node and LTE is the secondary (5GCN employed)
NGEN-DC (Option 7): LTE is the master node and NR is the secondary (5GCN employed)
NR-DC (variant of Option 2): Dual connectivity where both the master node, MN, controlling the MCG, and the secondary node, SN, controlling the SCG, are NR (5GCN employed, as depicted in FIG. 3).

FIG. 3 is a block diagram illustrating an example of NR dual connectivity. In the illustrated example, the UE is connected to both a NR master node and a NR secondary node.

3GPP specifications also include conditional handover (CHO). Conditional handover was standardized as a solution to increase the robustness at handover. To avoid the undesired dependence on the serving radio link upon the time (and radio conditions) when the UE should execute the handover, conditional handover standardizes the ability to provide RRC signaling for the handover to the UE earlier. The handover (HO) command may be associated with a condition, e.g., based on radio conditions possibly similar to the ones associated to an A3 event, where a given neighbor becomes X dB better than target. When the condition is fulfilled, the UE executes the handover in accordance with the provided handover command.

Such a condition may, e.g., be that the quality of the target cell or beam becomes X dB stronger than the serving cell. The threshold Y used in a preceding measurement reporting event should then be chosen lower than the one in the handover execution condition. This enables the serving cell to prepare the handover upon reception of an early measurement report and to provide the RRCConnectionReconfiguration with mobilityControlInfo (or the RRCReconfiguration with reconfigurationWithSync) at a time when the radio link between the source cell and the UE is still stable. The execution of the handover is done at a later point in time (and threshold), which is considered optimal for the handover execution. An example is illustrated in FIG. 4.

FIG. 4 is a flowchart illustrating the steps of an example conditional handover procedure. FIG. 4 depicts an example with a serving and a target cell. In practice there may often be many cells or beams that the UE reports as possible candidates based on its preceding radio resource management (RRM) measurements. The network then has the freedom to issue conditional handover commands for several of the candidates. The RRCConnectionReconfiguration/RRCReconfiguration message for each of the candidates may differ not just concerning the target cell but also, e.g., in terms of the HO execution condition (reference signal (RS) to measure and threshold to exceed) as well as in terms of the random access (RA) preamble to send when a condition is met.

While the UE evaluates the condition, it continues operating per its current RRC configuration, i.e., without applying the conditional HO command. When the UE determines that the condition is fulfilled, the UE disconnects from the serving cell, applies the conditional HO command and connects to the target cell. These steps are equivalent to legacy handover execution.

When the UE has successfully performed the random access procedure towards the target cell during a conditional handover or a normal handover, the UE then releases all the conditional reconfigurations that the UE has stored. The target cell may then configure new conditional reconfigurations for the UE if needed.

3GPP also includes conditional PSCell change (CPC). A UE operating in MR-DC receives in a conditional reconfiguration one or multiple RRC Reconfiguration(s) (e.g., a RRCReconfiguration message) containing a SCG configuration (e.g., a secondaryCellGroup of IE CellGroupConfig) with a reconfigurationWithSync that is stored and associated to an execution condition (e.g., a condition like an A3/A5 event configuration), so that one of the stored messages is only applied upon the fulfillment of the execution condition, e.g., associated with the serving PSCell, upon which the UE would perform PSCell change (if the UE finds a neighbor cell that is better than the current SpCell of the SCG). Only intra-SN CPC without MN involvement is standardized in 3GPP Rel-16, i.e., for cases where the (candidate) target PSCells are located in the current serving SN.

Similar to conditional handover, if a random access was performed for a target PSCell and the UE was configured with CPC, the UE then releases all the conditional reconfigurations that it has stored.

3GPP also includes conditional PSCell addition (CPA) and inter-SN CPC. 3GPP Rel-17 may include solutions for CPA and inter-SN CPC. The CPA procedure is used for adding a PSCell/SCG to the configuration for a UE that is currently only configured with an MCG, when associated execution conditions are fulfilled. CPA is initiated by the MN by requesting an SCG configuration, which is provided as part of a conditional reconfiguration to the UE, from a (candidate) target SN (T-SN), and then sending it in a conditional reconfiguration to the UE together with the associated execution conditions.

The inter-SN CPC may be initiated either by the MN or by the source SN (S-SN), where the signaling towards the source SN and the (candidate) target SNs, as well as towards the UE, in both cases is handled by the MN. One of the possible signaling sequences for configuration of an inter-SN CPC, which is initiated by the source SN, can be seen in the signaling flow in FIG. 5.

FIG. 5 is a flowchart illustrating an example inter-SN CPC procedure. Also for conditional PSCell change and conditional PSCell addition, the UE configured with CPC/CPA releases the CPC/CPA configurations when completing random access towards the target PSCell.

A UE may be configured with CHO and CPC simultaneously. However, the specification impact has not been thoroughly analyzed.

There currently exist certain challenges. For example, conditional reconfigurations are released in the UE upon execution of any conditional reconfiguration or upon execution of reconfigurationWithSync in the MCG or at reconfigurationWithSync in the SCG if CPC or CPA is configured. That means that the UE releases the conditional reconfigurations if a handover is executed, but at PSCell change only if CPA or CPC is configured when the condition is fulfilled.

When the UE releases the conditional reconfigurations, the network should also release the conditional reconfigurations to avoid mismatch in the configurations between the UE and the network and also to free up network resources. However, the network configurations are performed by both the MN and the SN, and one node may not be aware of what reconfigurations are done in the other node. An example is illustrated in FIG. 6.

FIG. 6 is a flowchart illustrating example CHO and CPC configurations using SRB1. In FIG. 6, the MN is not aware that the SN has configured the UE with CPC, because the RRCReconfiguration message is transparent to the MN and just forwarded to the UE. Also, when the CPC is executed, the RRCReconfigurationComplete message within ULInformationTransferMRDC is forwarded to the SN as a container, i.e., it is transparent to the MN. The UE thus releases the conditional reconfigurations, but the MN is not aware of the release.

There is also a problem if a UE is configured with CHO and CPC. If a legacy PSCell change is triggered, then the UE will release all conditional reconfigurations. PSCell change may be performed in the SN without any indication being sent to the MN.

FIG. 7 is a flowchart illustrating example CHO and CPC configurations using SRB3. In the illustrated example, the SN communicates directly with the UE. Also in this case, the MN is not aware that the UE has been configured with CPC. There is no message passed via the MN, thus the MN does not know that the UE is configured with CPC. The MN is also unaware of other reconfigurations in the SN, such as reconfigurationWithSync.

### SUMMARY

As described above, certain challenges currently exist with conditional reconfiguration involving multiple network nodes. Certain aspects of the present disclosure and their embodiments may provide solutions to these or other challenges. For example, particular embodiments include a method executed by a source secondary node (S-SN). The method comprises determining to configure intra-SN conditional PSCell change (CPC) and preparing CPC configurations including execution conditions and target configuration. The method further comprises transmitting to a master node (MN), a message that may contain a Radio Resource Control (RRC) reconfiguration message to the UE including the configuration of CPC (for SRB1).

In some embodiments, the message contains an indication to the MN that the SN configures the UE with CPC. In one option, the indication may comprise the number of conditional reconfigurations that were/will be configured in the UE.

The method may further comprise receiving, from the MN, an indication that the S-SN shall inform the MN of reconfigurations taking place in the SN, such as e.g. reconfigurationWithSync in the SN. The reconfigurationWithSync may be, e.g., PSCell change or the execution of CPC.

The method may further comprise informing the MN when a reconfiguration, such as e.g. reconfigurationWithSync, occurs in the SN.

Some embodiments include a method executed by a Master Node (MN). The method comprises receiving, from the SN, a message that contains an RRC reconfiguration message to the UE including the configuration of CPC (for SRB1). The message contains an indication to the MN that the SN configures the UE with CPC. In one option, the indication may comprise the number of conditional reconfigurations that were/will be configured in the UE.

The method may further comprise transmitting, to the SN, an indication that the SN shall inform the MN of reconfigurations taking place in the SN, such as e.g. reconfigurationWithSync in the SN. The reconfigurationWithSync may be, e.g., PSCell change or the execution of CPC.

The method may further comprise receiving information from the SN that a reconfiguration, such as e.g. reconfigurationWithSync, has occurred in the SN. Alternatively, the method may comprise receiving information from the UE that a reconfiguration, such as e.g. reconfigurationWithSync, has occurred in the SN.

Some embodiments include a method executed by a UE. The method comprises transmitting an RRC message to the MN, e.g. an ULInformationTransferMRDC message, including an SCG RRC Reconfiguration Complete generated upon execution of CPC (when the UE applies the RRC Reconfiguration in SN format upon fulfillment of the CPC execution condition(s)). The message contains an indication (explicit or implicit) to the MN that the UE has executed CPC.

In general, particular embodiments include information sent to a network node, such as an MN, of a conditional reconfiguration done in another network node, such as an SN or the UE. An indication may be sent from the SN or the UE to a MN to inform the MN when certain reconfigurations, such as reconfigurationWithSync, occur.

According to some embodiments, a method is performed in a wireless device operating in dual connectivity with a master node in a master cell group and a secondary node in a secondary cell group. The method comprises: obtaining one or more configurations for conditional reconfiguration; determining to execute a cell change in the secondary cell group; transmitting an indication to the master node of the cell change in the secondary cell group; and releasing the one or more configurations for conditional reconfiguration.

In particular embodiments, the indication comprises a RRC message, such as a ULInformationTransferMRDC message.

In particular embodiments, the one or more configurations for conditional reconfiguration comprise one or more configurations for at least one of CHO and CPC.

In particular embodiments, the method further comprises, in response to transmitting the indication to the master node of the cell change in the secondary cell group, receiving one or more configurations for conditional reconfiguration.

According to some embodiments, a wireless device comprises processing circuitry operable to perform any of the methods of the wireless device described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method is performed by a network node capable of operating as a source secondary node in a secondary cell group (SCG) for a wireless device operating in dual connectivity with a master node in a master cell group (MCG). The method comprises: configuring the wireless device with one or more configurations for conditional reconfiguration; receiving, from the master node, an indication that the source secondary node shall inform the master node of occurrence of cell change in the secondary cell group; and transmitting, to the master node, an indication of an occurrence of cell change in the secondary cell group for the wireless device.

In particular embodiments, the method further comprises transmitting an indication of the one or more configurations for conditional reconfiguration to the master node. The indication may comprise a number of conditional reconfigurations configured for the wireless device.

In particular embodiments, the one or more configurations for conditional reconfiguration comprise one or more configurations for at least one of a CHO, a CPC, and a CPA.

In particular embodiments, the cell change comprises a PSCell change.

In particular embodiments, transmitting the indication of the occurrence of the cell change for the wireless device to the master node comprises transmitting an XnAP message to the master node.

According to some embodiments, a method is performed by a network node capable of operating as a master node in a master cell group for a wireless device operating in dual connectivity with a source secondary node in a secondary cell group. The method comprises: obtaining an indication of one or more configurations for conditional reconfiguration for the wireless device; receiving an indication of an occurrence of a cell change in the secondary cell group for the wireless device; and based on the indication of the occurrence of the cell change in the secondary cell group for the wireless device, determining to update one or more configurations for conditional reconfiguration for the wireless device.

In particular embodiments, the method further comprises transmitting a request to the source secondary node to inform the master node of the occurrence of the cell change.

In particular embodiments, obtaining the indication of the one or more configurations for conditional reconfiguration comprises receiving the indication from the source secondary node. The indication of the one or more configurations for conditional reconfiguration may comprise a number of conditional reconfigurations configured for the wireless device. The one or more configurations for conditional reconfiguration comprise one or more configurations for at least one of a CHO, a CPC, and a CPA.

In particular embodiments, the indication of the occurrence of the cell change in the secondary cell group for the wireless device is received from one of the source secondary node and the wireless device.

In particular embodiments, the cell change comprises PSCell change.

In particular embodiments, receiving the indication of the occurrence of the cell change in the secondary cell group for the wireless device comprises receiving an XnAP message from the source secondary node.

According to some embodiments, a network node network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network nodes described above.

Certain embodiments may provide one or more of the following technical advantages. For example, particular embodiments facilitate a network node, such as an MN, to be informed when another network node, such as an SN, has configured a UE with conditional reconfiguration, or the UE has executed conditional reconfiguration. This enables the MN to know when the MN also has, or will, configure the UE with conditional reconfigurations to avoid mismatch between the configurations in the UE and in the network or to avoid exceeding a maximum number of conditional reconfigurations in the UE. Particular embodiments also ensure that the information is not sent between network nodes when it is not needed, i.e., particular embodiments avoid unnecessary network signaling.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a block diagram illustrating dual connectivity combined with carrier aggregation in multi-radio dual connectivity (MR-DC);

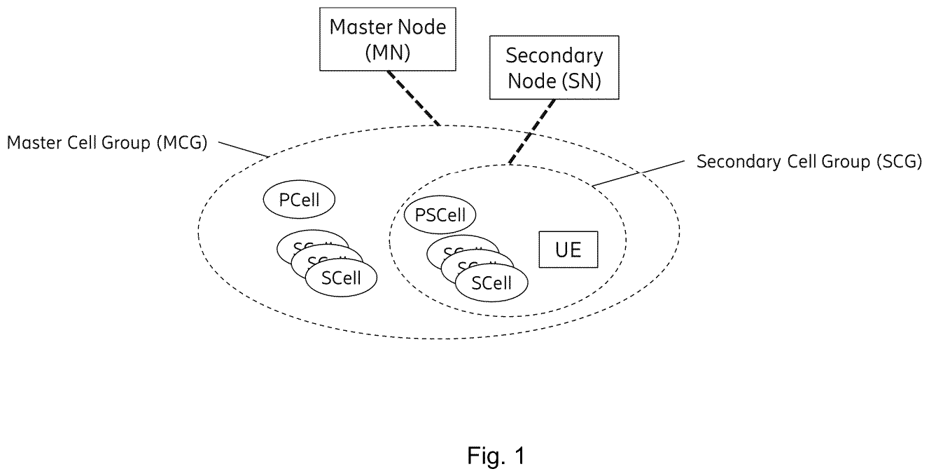

FIG. 2 is a block diagram illustrating an example of Long Term Evolution (LTE) and New Radio (NR) dual connectivity;

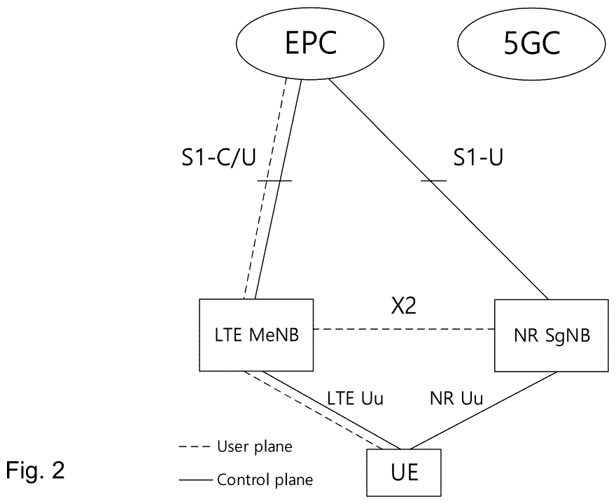

FIG. 3 is a block diagram illustrating an example of NR dual connectivity;

FIG. 4 is a flowchart illustrating the steps of an example conditional handover (CHO) procedure;

FIG. 5 is a flowchart illustrating an example inter-SN conditional PSCell change (CPC) procedure;

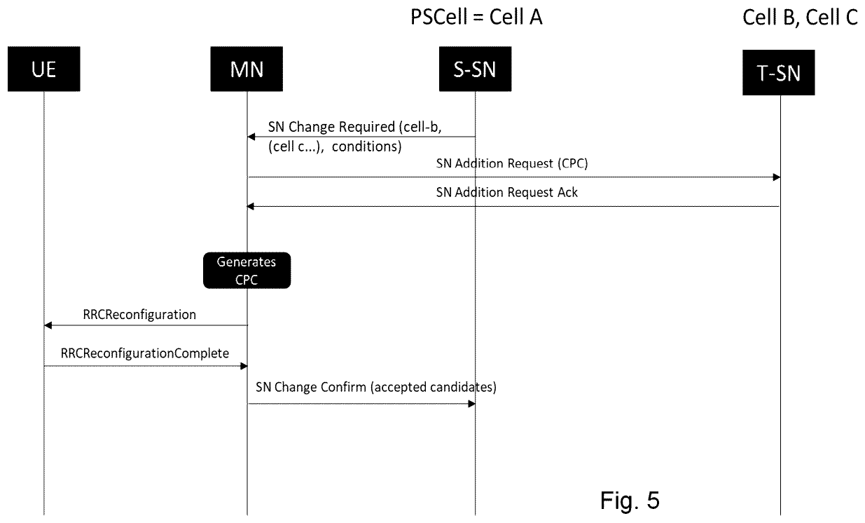

FIG. 6 is a flowchart illustrating example conditional CHO and CPC configurations using SRB1;

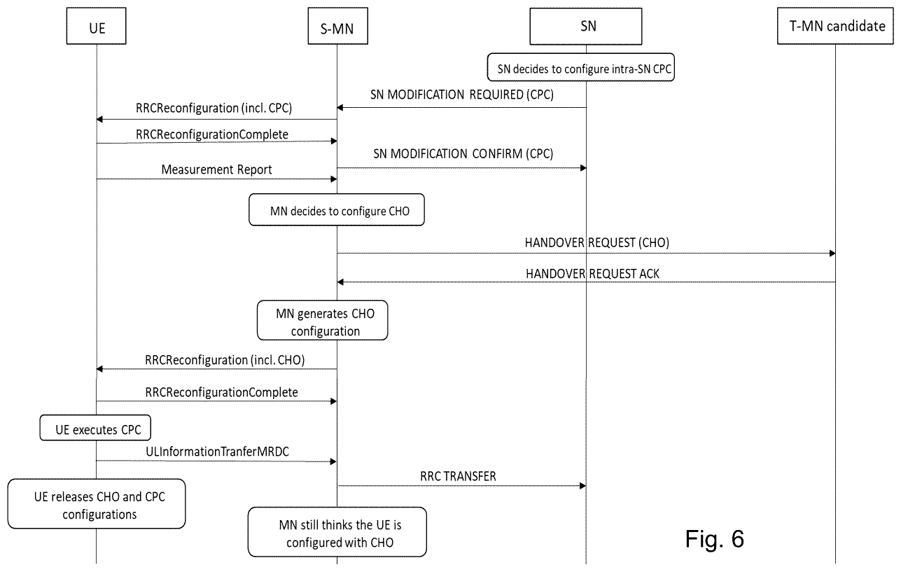

FIG. 7 is a flowchart illustrating example CHO and CPC configurations using SRB3;

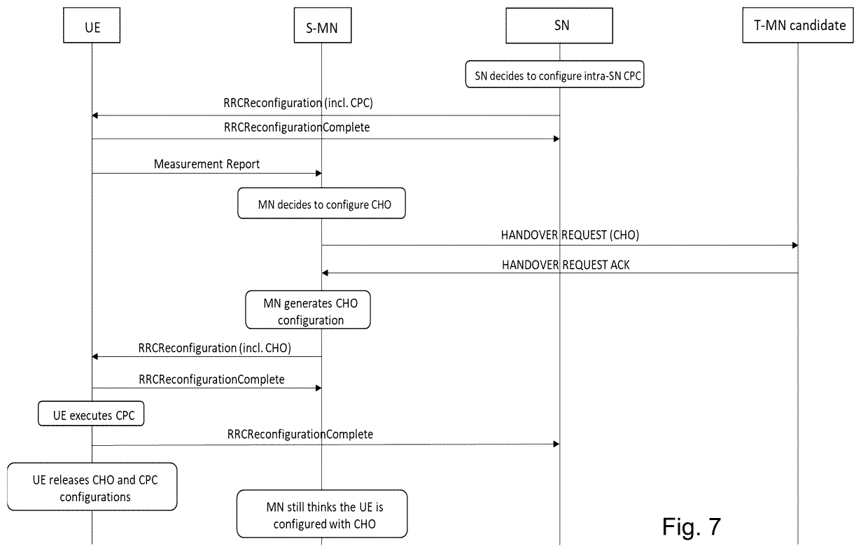

FIG. 8 is a flowchart illustrating an example method at a network node for CHO and/or CPC using SRB1, according to a particular embodiment;

FIG. 9 is a flowchart illustrating an example method at a network node for CHO and/or CPC using SRB3, according to a particular embodiment;

FIG. 10 is a flowchart illustrating an example method at a user equipment for CHO and/or CPC using SRB1, according to a particular embodiment;

FIG. 11 is a flowchart illustrating an example method at a user equipment for CHO and/or CPC using SRB3, according to a particular embodiment;

FIG. 12 illustrates an example communication system, according to certain embodiments;

FIG. 13 illustrates an example user equipment (UE), according to certain embodiments;

FIG. 14 illustrates an example network node, according to certain embodiments;

FIG. 15 illustrates a block diagram of a host, according to certain embodiments;

FIG. 16 illustrates a virtualization environment in which functions implemented by some embodiments may be virtualized, according to certain embodiments;

FIG. 17 illustrates a host communicating via a network node with a UE over a partially wireless connection, according to certain embodiments;

FIG. 18 illustrates a method performed by a wireless device, according to certain embodiments;

FIG. 19A illustrates a method performed by a network node in a secondary cell group (SCG), according to certain embodiments; and

FIG. 19B illustrates a method performed by a network node in a master cell group (MCG), according to certain embodiments.

### DETAILED DESCRIPTION

As described above, certain challenges currently exist with conditional reconfiguration involving multiple network nodes. Certain aspects of the present disclosure and their embodiments may provide solutions to these or other challenges. For example, particular embodiments include exchanging information regarding conditional reconfiguration between nodes, such as between a secondary node (SN) and a master node (MN) or a user equipment (UE) and a MN.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Particular embodiments and/or examples refer to a first network node operating as a MN, e.g., having a master cell group (MCG) configured to the user equipment (UE). The MN may comprise a gNodeB, a central unit gNodeB (CU-gNB), an eNodeB, a central unit eNodeB (CU-eNB), or any network node and/or network function. Particular embodiments also refer to a second network node operating as a SN, or source secondary node (S-SN), e.g., having a secondary cell group (SCG) pre-configured (i.e., not connected to) to the UE. The SN may comprise a gNodeB, a central unit gNodeB (CU-gNB), an eNodeB, a central unit eNodeB (CU-eNB), or any network node and/or network function. MN, S-SN and target SN (T-SN) may be from the same or different radio access technologies (RATs) (and possibly be associated to different core network nodes).

Some examples refer to a SN or T-SN. This is equivalent to referring to a target candidate SN or a network node associated to a target candidate PSCell that is being configured. If the UE connects to that cell, transmissions and receptions with the UE would be handled by that node if the cell is associated to that node.

Some examples describe that a cell resides in anode, e.g., a target candidate cell resides in the S-SN or the T-SN. This is equivalent to referring to a cell that is managed by the node, is associated to the node, is associated with the node, that the cell belongs to the node, or that the cell is of the node.

“SN-initiated CPC” corresponds to a procedure wherein the source SN for a UE configured with multiple-radio dual connectivity (MR-DC) determines to configure conditional PSCell change (CPC). Upon determining to configure CPC, the source SN selects, e.g. based on reported measurements, one or more target candidate cells (target candidate PSCell(s)) wherein at least one cell is associated to the source SN, and at least another cell is associated to a neighbor SN. If all target candidate cells are associated to the source SN, then it may be referred to as an “SN-initiated intra-SN CPC”, which may also be referred as the Release 16 solution. If at least one target candidate cell is associated to a neighbor SN, then it is referred to as an “SN-initiated inter-SN CPC”, which may also be referred as a Release 17 solution.

As used herein, a candidate SN, SN candidate, or an SN may be referred to as the network node (e.g., gNodeB) that is prepared during the conditional PSCell addition (CPA) procedure and that can create a Radio Resource Control (RRC) Reconfiguration message with an SCG configuration (e.g., RRCReconfiguration**) to be provided to the UE and stored, with an execution condition, wherein the UE only applies the message upon the fulfillment of the execution condition. The candidate SN is associated to one or multiple PSCell candidate cell(s) that the UE may be configured with. The UE then may execute the condition and access one of the candidate cells, associated to a candidate SN that becomes the SN or simply the SN after execution (i.e., upon fulfillment of the execution condition).

As used herein, CPC configuration and procedures (like CPC execution) most of the time to refers to the procedure from the UE perspective. Other terms may be considered as synonyms such as conditional reconfiguration, or conditional configuration (because the message that is stored and applied upon fulfillment of a condition is an RRCReconfiguration or RRCConnectionReconfiguration).

Conditional handover (CHO) may also be interpreted in a broader sense, also covering CPA and/or CPC procedures. A conditional SN change most of the time refers to the procedure from the UE perspective and refers to procedures between network nodes wherein a node requests a target candidate SN (which may be the same as the Source SN or a neighbor SN) to configure a CPA and/or CPC for at least one of its associated cells (cell associated to the target candidate SN). CPAC refers to either a CPA or a CPC.

A neighbor SN and a source SN may be referred to as different entities, though both may be a target candidate SN for CPC.

CPC configuration may be performed using the same information elements (IEs) as conditional handover, which may also be referred to as conditional configuration or conditional reconfiguration. The principle for the configuration is the same with configuring triggering/execution condition(s) and a reconfiguration message to be applied when the triggering condition(s) are fulfilled. The configuration IEs from TS 38.331 include the following.

The IE ConditionalReconfiguration is used to add, modify and release the configuration of conditional configuration.

ConditionalReconfiguration information element

-- ASN1START
-- TAG-CONDITIONALRECONFIGURATION-START

| ConditionalReconfiguration-r16 ::= | SEQUENCE { | |
|---|---|---|
| attemptCcondReconfig-r16 | ENUMERATED {true} | OPTIONAL, |

-- Need N

| | | |
|---|---|---|
| condConfigToRemoveList-r16 | CondConfigToRemoveList-r16 | OPTIONAL, -- Need |

N

| | | |
|---|---|---|
| condConfigToAddModList-r16 | CondConfigToAddModList-r16 | OPTIONAL, -- Need |

N
...
}

| | |
|---|---|
| CondConfigToRemoveList-r16 ::= | SEQUENCE (SIZE (1.. maxNrofCondCells)) OF |

CondConfigId-r16
-- TAG-CONDITIONALRECONFIGURATION-STOP
-- ASN1STOP

ConditionalReconfiguration field descriptions

condConfigToAddModList
List of the configuration of candidate SpCells to be added or modified for CHO or CPC.
condConfigToRemoveList
List of the configuration of candidate SpCells to be removed. When the network removes
the stored conditional configuration for a candidate cell, the network releases the measIDs
associated to the condExecutionCond if it is not used by the condExecutionCond of other
candidate cells.

The IE CondConfigId is used to identify a CHO or CPC configuration.

CondConfigId information element

| -- ASN1START | |
|---|---|
| -- TAG-CONDCONFIGID-START | |
| CondConfigId-r16 ::= | INTEGER (1.. maxNrofCond-Cells) |

-- TAG-CONDCONFIGID-STOP
-- ASN1STOP

The IE CHO-ConfigToAddModList concerns a list of conditional configurations to add or modify, with for each entry the cho-Configld and the associated condExecutionCond and condRRCReconfig.

CondConfigToAddModList information element

-- ASN1START
-- TAG-CONDCONFIGTOADDMODLIST-START

| | |
|---|---|
| CondConfigToAddModList-r16 ::= | SEQUENCE (SIZE (1.. maxNrofCondCells)) OF |

CondConfigToAddMod-r16

| | |
|---|---|
| CondConfigToAddMod-r16 ::= | SEQUENCE { |
| condConfigId-r16 | CondConfigId-r16, |
| condExecutionCond-r16 | SEQUENCE (SIZE (1..2)) OF MeasId |

OPTIONAL, -- Need S

| | |
|---|---|
| condRRCReconfig-r16 | OCTET STRING (CONTAINING |

RRCReconfiguration) OPTIONAL, -- Need S
...
}
-- TAG-CONDCONFIGTOADDMODLIST-STOP
-- ASN1STOP

CondConfigToAddMod field descriptions

condExecutionCond
The execution condition that needs to be fulfilled in order to trigger the execution of a
conditional configuration. The field is mandatory present when a condConfigId is being
added. Otherwise, when the condRRCReconfig associated to a condConfigId is being
modified it is optionally present and the UE uses the stored value if the field is absent.
condRRCReconfig
The RRCReconfiguration message to be applied when the condition(s) are fulfilled. The
field is mandatory present when a condConfigId is being added. Otherwise, when the
condExecutionCond associated to a condConfigId is being modified it is optionally present
and the UE uses the stored value if the field is absent.

In particular embodiments, the CPC is in MN format when the CPC configuration is not configured as an MR-DC configuration in mrdc-SecondaryCellGroup (as defined in TS 38.331). In other words, the UE receives an RRCReconfiguration from the MN that may contain the mrdc-SecondaryCellGroup (e.g., when the UE is also configured with an SCG MeasConfig for inter-SN CPC) but the CPC is not within that container. That means the IEs listed above (e.g., the IE ConditionalReconfiguration) are not included in mrdc-SecondaryCellGroup.

In particular embodiments, the CPC is in SN format when the CPC configuration is configured as an MR-DC configuration in mrdc-SecondaryCellGroup (as defined in TS 38.331). In other words, the UE receives an RRCReconfiguration from the MN that may contain the mrdc-SecondaryCellGroup and the CPC is within that container. That means the IEs listed above (e.g., the IE ConditionalReconfiguration) are included in mrdc-SecondaryCellGroup (e.g., within a series of other nested IEs).

The terms CHO and MR-DC are used for configurations where a CHO configuration contains the configuration of both an MCG and an SCG.

The case of mobility in the SN is described, but particular embodiments may apply to any type of reconfiguration in the SN.

Some embodiments include network centric approaches, such as handling of SN mobility when CHO and CPC is configured.

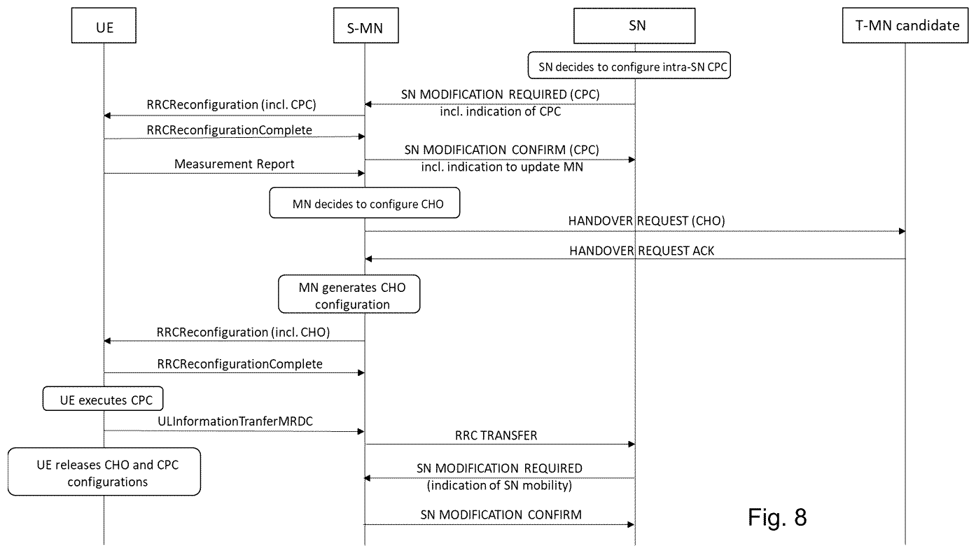

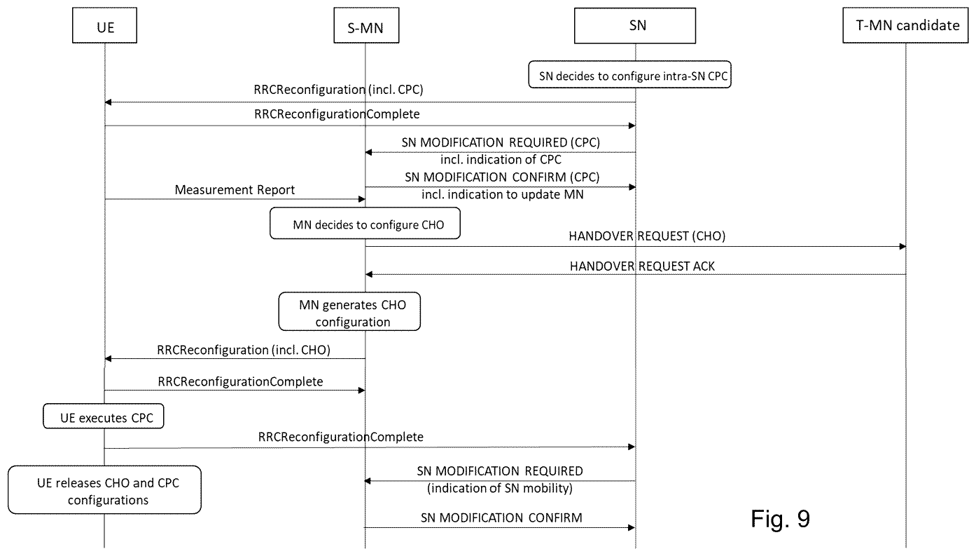

FIG. 8 is a flowchart illustrating an example method at a network node for CHO and/or CPC using SRB1, according to a particular embodiment. FIG. 9 is a flowchart illustrating an example method at a network node for CHO and/or CPC using SRB3, according to a particular embodiment.

In general, FIG. 8 illustrates how the SN may inform the MN of CPC execution, the MN requesting from the SN information related to mobility events in the SN, and the SN informing the MN when mobility events occur. FIG. 9 illustrates the same scenario, but when the UE is configured with SRB3, i.e., direct communication between the SN and the UE.

Particular embodiments include a method executed by a source secondary node (S-SN) using SRB1. The method comprises determining to configure intra-SN CPC and preparing CPC configurations including execution conditions and target configuration.

The method further comprises transmitting, to the MN, a message containing an RRC reconfiguration message sent to the UE that includes the configuration of CPC. The message may correspond to an S-NODE MODIFICATION REQUIRED or another message. In general, the message contains an indication to the MN that the SN configured the UE with CPC. The indication may be part of the XnAP message, e.g. S-NODE MODIFICATION REQUIRED, part of an inter-node message, e.g. CG-Config or part of a container within an XnAP message. One benefit of indicating that the RRC reconfiguration is configuring the UE with CPC is that the MN does not need to determine that by processing the RRC reconfiguration message from the S-SN, which may be from another radio access technology, e.g., NR for EN-DC.

At this point, the MN is aware that the UE is being configured with CPC. When CPC is executed by the UE, the MN becomes aware that if the UE is also configured with CHO configuration (e.g., for one or more candidates), the CHO configurations will be deleted.

In one option, the indication may comprise the number of conditional reconfigurations that were/will be configured in the UE.

The example method further comprises receiving, from the MN, an indication that the S-SN shall inform the MN of reconfigurations taking place in the SN such as, e.g. reconfigurationWithSync, in the SN. The reconfigurationWithSync may be, e.g., PSCell change or the execution of CPC.

In some embodiments, the message comprises an S-NODE MODIFICATION CONFIRM message. In some embodiments, the indication may be omitted.

In some embodiments, the indication may comprise a request for receiving the notification when a PSCell change occurs, e.g., either triggered by a PSCell change or a CPC execution.

In some embodiments, this is only required when the S-SN triggers a PSCell change using SRB3 (see e.g., FIG. 9). One reason is that if SRB3 is used, the MN does not need to be involved and is not aware that a PSCell change is being executed and that CHO configurations for the UE are being deleted.

If the UE is configured with SRB1, the indication step may be omitted by the MN if the MN determines that it is able to determine that a UE configured with CPC executes CPC, because the UE sends an uplink message to the MN (e.g., ULInformationTransferMRDC including the SCG RRC Reconfiguration Complete generated and transmitted by the UE when CPC is executed).

The example method further comprises informing the MN when a reconfiguration, such as e.g. reconfigurationWithSync, occurs in the SN. The SN may inform the MN of reconfigurationWithSync in an S-NODE MODIFICATION REQUIRED or another message including a new message. In some embodiments, the information may comprise a new cause value. The information may be sent using an existing message or cause value.

In some use cases, e.g. when CHO and MR-DC is configured, only the step of informing the MN when a reconfiguration, such as reconfigurationWithSync, occurs in the SN may be executed. The other steps above including sending an indication from the SN of the configuration of CPC and the request to the SN to inform the MN of reconfigurations in the SN may be omitted, because the SN in certain cases implicitly understands that it needs to inform the MN of reconfigurations in the SN.

In some embodiments, the MN always informs the S-SN about the occurrence of a PSCell change and/or a CPC execution. In some embodiments, that is performed by the S-SN if the MN performs the previous step of requesting to receive an indication upon CPC execution and/or PSCell change.

In some embodiments, if SRB3 is used by the S-SN for configuring CPC in the UE, the S-SN may perform the following method steps. For example, the S-SN may determine to configure intra-SN CPC and prepare CPC configurations including execution conditions and target configuration.

The S-SN may transmit an RRC reconfiguration message to the UE. The message includes the configuration of CPC.

The S-SN may receive a response message from the UE and transmit a message to the MN. The message may comprise an S-NODE MODIFICATION REQUIRED or another message including a new message. The message contains an indication to the MN that the SN configures the UE with CPC. The indication may be part of the XnAP message, e.g. S-NODE MODIFICATION REQUIRED, part of an inter-node message, e.g. CG-Config or part of a container within an XnAP message.

In some embodiments, the indication may comprise the number of conditional reconfigurations that were/will be configured in the UE. The message may comprise an S-NODE MODIFICATION REQUIRED or another existing XnAP message. The message may comprise a new message, such as a class 2 message, i.e., a message that does not require a response from the MN.

The example method further comprises receiving, from the MN, an indication that the SN shall inform the MN of reconfigurations taking place in the SN such as e.g. reconfigurationWithSync in the SN. The reconfigurationWithSync may be, e.g., PSCell change or the execution of CPC.

The message may comprise an existing XnAP message, e.g., S-NODE MODIFICATION CONFIRM. The message may comprise a new XnAP message. In some embodiments, the message may be omitted.

The example method further comprises informing the MN when a reconfiguration, such as e.g. reconfigurationWithSync, occurs in the SN. The SN may inform the MN of reconfigurationWithSync in an S-NODE MODIFICATION REQUIRED or another message including a new message.

In some embodiments, the information may comprise a new cause value. The information may be sent using an existing message or cause value. In some use cases, e.g. when CHO and MR-DC is configured, only the step of informing the MN when a reconfiguration such as reconfigurationWithSync occurs in the SN may be executed. The other steps above that include sending an indication from the SN of the configuration of CPC and the request to the SN to inform the MN of reconfigurations in the SN may be omitted, because the SN in certain cases implicitly understands that the SN needs to inform the MN of reconfigurations in the SN.

Some embodiments include a method executed by a MN using SRB1. The method comprises receiving, from the SN, a message containing an RRC reconfiguration message sent to the UE including the configuration of CPC. The message may comprise an S-NODE MODIFICATION REQUIRED or another message including a new message.

The message contains an indication to the MN that the SN configures the UE with CPC. The indication may comprise part of the XnAP message, e.g. S-NODE MODIFICATION REQUIRED, part of an inter-node message, e.g. CG-Config, or part of a container within an XnAP message. In one option, the indication may comprise the number of conditional reconfigurations that were/will be configured in the UE.

The method further comprises transmitting, to the SN, an indication that the SN shall inform the MN of reconfigurations taking place in the SN, such as e.g. reconfigurationWithSync in the SN. The reconfigurationWithSync may be, e.g., PSCell change or the execution of CPC. In some embodiments, the indication may be omitted. The message may comprise an existing XnAP message, e.g., S-NODE MODIFICATION CONFIRM.

The example method further comprises receiving information from the SN that a reconfiguration, such as e.g. reconfigurationWithSync, has occurred in the SN. The MN may be informed of reconfigurationWithSync in an S-NODE MODIFICATION REQUIRED by, for example, a new indicator or another message including a new message. The information may comprise a new cause value. The information may be sent using an existing message or cause value.

In some use cases, e.g. when CHO and MR-DC is configured, only the step of informing the MN when a reconfiguration such as reconfigurationWithSync occurs in the SN may be executed. The other steps above that include sending an indication to the MN of configuration of CPC in the SN and the request from the MN to the SN to inform the MN of reconfigurations in the SN may be omitted, because the SN in certain cases implicitly understands that the SN needs to inform the MN of reconfigurations in the SN.

Some embodiments may use SRB3. In these embodiments, the method comprises receiving a message from the SN. The message may comprise an S-NODE MODIFICATION REQUIRED or another message including a new message.

The message contains an indication to the MN that the SN configures the UE with CPC. The indication may be part of the XnAP message, e.g. S-NODE MODIFICATION REQUIRED, part of an inter-node message, e.g. CG-Config, or part of a container within an XnAP message. In one option, the indication may comprise the number of conditional reconfigurations that were/will be configured in the UE.

The message may comprise an S-NODE MODIFICATION REQUIRED, or another existing XnAP message. The message may be a new message, such as a class 2 message, i.e., a message that does not require a response from the MN.

The example method further comprises transmitting, to the SN, an indication that the SN shall inform the MN of reconfigurations taking place in the SN, such as e.g. reconfigurationWithSync in the SN. The reconfigurationWithSync may be, e.g., PSCell change or the execution of CPC.

The message may comprise an S-NODE MODIFICATION CONFIRM message. The message may be a new message. In some embodiments, the message may be omitted.

The example method further comprises receiving information from the SN that a reconfiguration, such as e.g. reconfigurationWithSync, has occurred in the SN. The MN may be informed of reconfigurationWithSync in an S-NODE MODIFICATION REQUIRED or another message including a new message.

The information may comprise a new cause value. The information may be sent using existing message or cause value. In some use cases, e.g. when CHO and MR-DC is configured, only the step of informing the MN when a reconfiguration such as reconfigurationWithSync occurs in the SN may be executed. The other steps above that include sending an indication from the SN of the configuration of CPC and the request to the SN to inform the MN of reconfigurations in the SN may be omitted, because the SN in certain cases implicitly understands that the SN needs to inform the MN of reconfigurations in the SN.

Some embodiments include a method executed by a MN. The method comprises reestablishing the CHO(s). For example, upon determining that the UE has discarded CHO configurations, the MN may decide to reestablish the CHOs.

Reestablishing the CHOs may be done by transmitting to candidate target MNs requests for CHOs. The target MNs may respond by providing new CHOs for the UE. The CHOs may be the same CHO configurations that the candidate target MNs provided earlier (i.e., those that the UE discarded).

Alternatively, reestablishing the CHOs may be done by the MN storing the CHO configurations that it has received from the target MNs when they were configured earlier (i.e., the CHO configurations that the UE has discarded). The benefit of this is that the MN does not need to trigger a new procedure to establish CHOs (involving the target MNs). However, this requires that the source MN remember the CHOs, because the UE may (potentially) discard them. This may increase memory requirements in the MN.

The following is an example implementation in XnAP specification TS 38.423 of addition of an indicator that the SN has added a conditional reconfiguration to the UE. The example implementation also shows the addition of a request from the MN to the SN to send information to the MN of any reconfigurationWithSync in the SN. This is only one example, and other modifications or terminology may be used to modify the specification.

The S-NODE MODIFICATION REQUIRED message is sent by the S-NG-RAN node to the M-NG-RAN node to request the modification of S-NG-RAN node resources for a specific UE.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| M-NG-RAN node UE | M | | NG-RAN node | Allocated at the M- | YES | reject |
| XnAP ID | | | UE XnAP ID | NG-RAN node | | |
| | | | 9.2.3.16 | | | |
| S-NG-RAN node UE | M | | NG-RAN node | Allocated at the S- | YES | reject |
| XnAP ID | | | UE XnAP ID | NG-RAN node | | |
| | | | 9.2.3.16 | | | |
| Cause | M | | 9.2.3.2 | | YES | ignore |
| PDCP Change Indication | O | | 9.2.3.74 | | YES | ignore |
| PDU Session Resources | | 0 . . . 1 | | | YES | ignore |
| To Be Modified List | | | | | | |
| >PDU Session | | 1 . . . | | NOTE: If neither the | — | |
| Resources To Be | | <maxnoofPDUSes- | | PDU Session | | |
| Modified Item | | sions> | | Resource | | |
| | | | | Modification | | |
| | | | | Required Info - SN | | |
| | | | | terminated IE | | |
| | | | | nor the | | |
| | | | | PDU Session | | |
| | | | | Resource | | |
| | | | | Modification | | |
| | | | | Required Info - MN | | |
| | | | | terminated IE | | |
| | | | | is present in a PDU | | |
| | | | | Session Resources | | |
| | | | | To Be Modified Item | | |
| | | | | IE, abnormal | | |
| | | | | conditions as | | |
| | | | | specified in clause | | |
| | | | | 8.3.4.4 apply. | | |
| >>PDU Session ID | M | | 9.2.3.18 | | — | |
| >>PDU Session | O | | 9.2.1.20 | | — | |
| Resource Modification | | | | | | |
| Required Info - SN | | | | | | |
| terminated | | | | | | |
| >>PDU Session | O | | 9.2.1.22 | | — | |
| Resource Modification | | | | | | |
| Required Info - MN | | | | | | |
| terminated | | | | | | |
| PDU Session Resources | | 0 . . . 1 | | | YES | ignore |
| To Be Released List | | | | | | |
| >PDU Session | | 1 . . . | | | — | |
| Resources To Be | | <maxnoofPDUSes- | | | | |
| Released Item | | sions> | | | | |
| >PDU sessions to be | O | | PDU session | | — | |
| released List - SN | | | List with data | | | |
| terminated | | | forwarding | | | |
| | | | request info | | | |
| | | | 9.2.1.24 | | | |
| >PDU sessions to be | O | | PDU session | | — | |
| released List - MN | | | List with Cause | | | |
| terminated | | | 9.2.1.26 | | | |
| S-NG-RAN node to M- | O | | OCTET | Includes the CG- | YES | ignore |
| NG-RAN node Container | | | STRING | Config message or | | |
| | | | | the CG- | | |
| | | | | CandidateList | | |
| | | | | message as defined | | |
| | | | | in subclause 11.2.2 | | |
| | | | | of TS 38.331. | | |
| Spare DRB IDs | O | | DRB List | Indicates the list of | YES | ignore |
| | | | 9.2.1.29 | unnecessary DRB | | |
| | | | | IDs that had been | | |
| | | | | used by the S-NG- | | |
| | | | | RAN node. | | |
| Required Number of DRB | O | | Number of | Indicates the number | YES | ignore |
| IDs | | | DRBs | of DRB IDs that the | | |
| | | | 9.2.3.78 | S-NG-RAN node | | |
| | | | | requests more. | | |
| Location Information at S- | O | | Target Cell | Contains information | YES | ignore |
| NODE | | | Global ID | to support | | |
| | | | 9.2.3.25 | localisation of the | | |
| | | | | UE | | |
| MR-DC Resource | O | | 9.2.2.33 | Information used to | YES | ignore |
| Coordination Information | | | | coordinate resource | | |
| | | | | utilisation between | | |
| | | | | M-NG-RAN node | | |
| | | | | and S-NG-RAN | | |
| | | | | node. | | |
| RRC Config Indication | O | | 9.2.3.72 | | YES | reject |
| SCG Indicator | O | | ENUMERATED | | YES | ignore |
| | | | (released, . . . ) | | | |
| SCG UE History | O | | 9.2.3.151 | | Yes | ignore |
| Information | | | | | | |
| SCG Activation Request | O | | 9.2.3.154 | | YES | ignore |
| Conditional PSCell | O | | | | YES | ignore |
| Addition Information | | | | | | |
| Required | | | | | | |
| >Candidate PSCell ID | | 1 | | | — | |
| List | | | | | | |
| >>Candidate PSCell ID | | 1 . . . | | | — | |
| Item | | <maxnoofPSCellCandidate> | | | | |
| >>>PSCell ID | M | | NR CGI 9.2.2.7 | | — | |
| Conditional | O | | ENUMERATED | Contains information | YES | ignore |
| reconfiguration indicator | | | (cpc, . . . ) | of conditional | | |
| | | | | reconfiguration | | |

| Range bound | Explanation |
|---|---|
| maxnoofPDUSessions | Maximum no. of PDU sessions. Value is 256 |
| maxnoofPSCellCandidate | Maximum no, of PSCell candidate. Value is 8 |

The S-NODE MODIFICATION CONFIRM message is sent by the M-NG-RAN node to inform the S-NG-RAN node about the successful modification.

| | | | IE type and | | | Assigned |
|---|---|---|---|---|---|---|
| IE/Group Name | Presence | Range | reference | Semantics description | Criticality | Criticality |
| Message Type | M | | 9.2.3.1 | | YES | reject |
| M-NG-RAN node UE | M | | NG-RAN node | Allocated at the M-NG- | YES | ignore |
| XnAP ID | | | UE XnAP ID | RAN node | | |
| | | | 9.2.3.16 | | | |
| S-NG-RAN node UE | M | | NG-RAN node | Allocated at the S-NG- | YES | ignore |
| XnAP ID | | | UE XnAP ID | RAN node | | |
| | | | 9.2.3.16 | | | |
| PDU sessions Admitted | | 0 . . . 1 | | | YES | ignore |
| To Be Modified List | | | | | | |
| >PDU sessions | | 1 . . . | | NOTE: If neither the | — | |
| Admitted To Be Modified | | <maxnoofPDUses- | | PDU Session Resource | | |
| Item | | sions> | | Modification Confirm | | |
| | | | | Info - SN terminated IE | | |
| | | | | nor the | | |
| | | | | PDU Session Resource | | |
| | | | | Modification Confirm | | |
| | | | | Info - MN terminated IE | | |
| | | | | is present in a PDU | | |
| | | | | Session Resources | | |
| | | | | Admitted To Be | | |
| | | | | Modified Item IE, | | |
| | | | | abnormal conditions as | | |
| | | | | specified in clause | | |
| | | | | 8.3.4.4 apply. | | |
| >>PDU Session ID | M | | 9.2.3.18 | | — | |
| >>PDU Session | O | | 9.2.1.21 | | — | |
| Resource Modification | | | | | | |
| Confirm Info - SN | | | | | | |
| terminated | | | | | | |
| >>PDU Session | O | | 9.2.1.23 | | — | |
| Resource Modification | | | | | | |
| Confirm Info - MN | | | | | | |
| terminated | | | | | | |
| PDU sessions Released | | 0 . . . 1 | | | YES | ignore |
| List | | | | | | |
| >PDU sessions released | O | | PDU Session | | — | |
| List - SN terminated | | | List with data | | | |
| | | | forwarding info | | | |
| | | | from the target | | | |
| | | | node | | | |
| | | | 9.2.1.25 | | | |
| >PDU sessions released | O | | PDU session List | | — | |
| List - MN terminated | | | 9.2.1.27 | | | |
| M-NG-RAN node to S- | O | | OCTET STRING | Includes the | YES | ignore |
| NG-RAN node Container | | | | RRCReconfigurationComplete | | |
| | | | | message as | | |
| | | | | defined in subclause | | |
| | | | | 6.2.2 of TS 38.331 [10] | | |
| | | | | or the | | |
| | | | | RRCConnectionReconfig- | | |
| | | | | urationComplete | | |
| | | | | message as defined in | | |
| | | | | 36.331. | | |
| | | | | subclause 6.2.2 of TS | | |
| | | | | 36.331. | | |
| Additional DRB IDs | O | | DRB List | Indicates additional list | YES | reject |
| | | | 9.2.1.29 | of DRB IDs that the S- | | |
| | | | | NG-RAN node may use | | |
| | | | | for SN-terminated | | |
| | | | | bearers. | | |
| Criticality Diagnostics | O | | 9.2.3.3 | | YES | ignore |
| MR-DC Resource | O | | 9.2.2.33 | Information used to | YES | Ignore |
| Coordination Information | | | | coordinate resource | | |
| | | | | utilisation between M- | | |
| | | | | NG-RAN node and S- | | |
| | | | | NG-RAN node. | | |
| Reconfiguration | O | | ENUMERATED(true, | Request for information | YES | Ignore |
| information request | | | . . . ) | of | | |
| | | | | reconfiguration With Syn | | |
| | | | | c in S-NG-RAN node. | | |

| Range bound | Explanation |
|---|---|
| maxnoofPDUSessions | Maximum no. of PDU sessions. Value is 256 |

The embodiments above may be referred to as network-centric. Some embodiments are UE-centric.

According to some embodiments, a UE indicates to the MN that the UE has discarded one or more CHO configurations, e.g., as a result of the procedure described above (e.g., in response to CPC execution). The UE may indicate this by sending an RRC message to the MN. The message may be triggered upon execution of the CPC when the UE discards the CHOs.

The RRC message to the MN may comprise an ULInformationTransferMRDC message, including an SCG RRC Reconfiguration Complete generated upon execution of CPC (when the UE applies the RRC Reconfiguration in SN format upon fulfillment of the CPC execution condition(s)).

The inclusion of the RRC SCG RRC Reconfiguration Complete in the message, possibly associated with the MN understanding that the UE was configured with CPC, enables the MN to determine that the reception of the ULInformationTransferMRDC including RRC SCG RRC Reconfiguration Complete means that the UE has executed CPC, and consequently has deleted CHO configuration(s), e.g., one or more configuration(s) per CHO candidate cell and/or CHO execution conditions and/or CHO related measurement configurations (associated to the CHO trigger conditions, measurement objects and measurement identifiers).

In another option, the UE includes an indication in the ULInformationTransferMRDC message. The indication may be in MN format and readable by the MN, and enable the MN to determine that the message is triggered by the CPC execution. One advantage is that the MN does not need to check the content of the message in SN format included in the ULInformationTransferMRDC.

The MN may, upon receiving such an indication from the UE, determine that the CHO is obsolete/not valid. In response, the MN may re-establish the CHO(s) if needed, or cancel (not reestablish) the CHO(s) if not needed.

Whether the UE sends such indications (CHO release indications) to the MN may be configurable by the network. For example, if the network is using a network-centric approach to address the problem, there may be no need for the UE to indicate the CHO release because the SN will indicate this to the MN. Therefore, the MN may decide to not configure the UE to send CHO release indications.

In one option, a network centric approach is combined with a UE centric approach. This option may, e.g., comprise the SN indicating to the MN that it configures the UE with CPC. Later, when a CPC is executed, the UE indicates to the network that it has executed CPC (and released other conditional reconfigurations). The option may be likely if SRB1 is used.

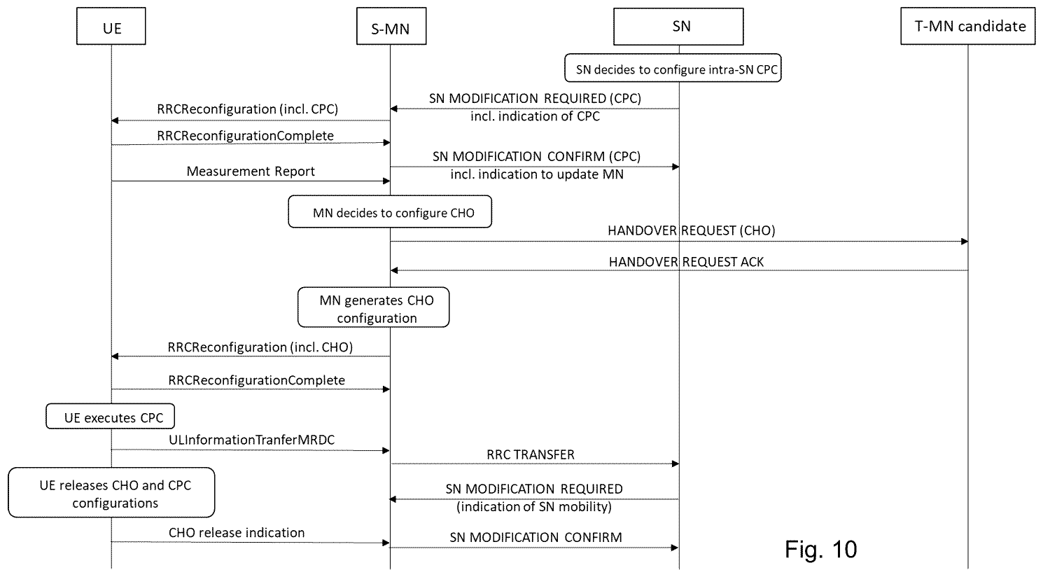

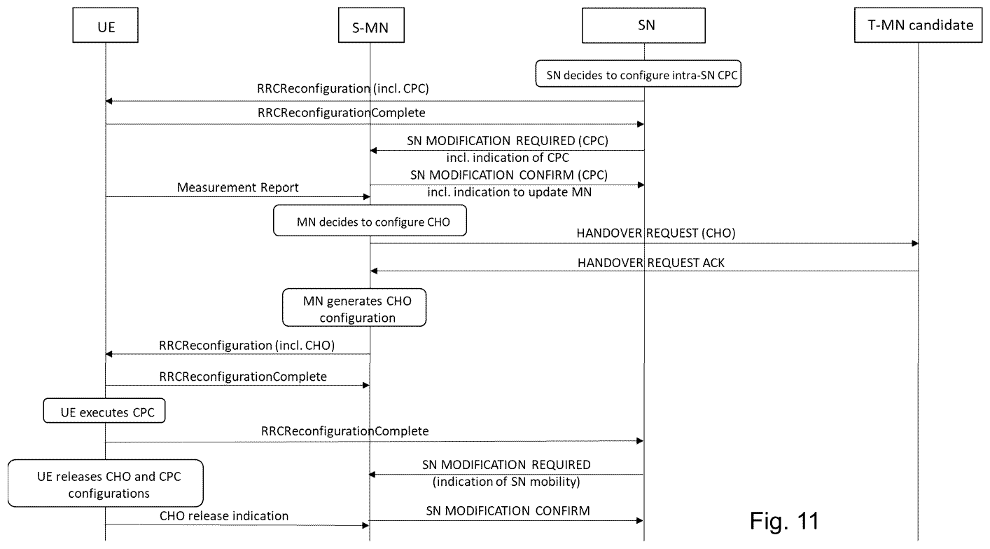

FIG. 10 is a flowchart illustrating an example method at a user equipment for CHO and/or CPC using SRB1, according to a particular embodiment. FIG. 11 is a flowchart illustrating an example method at a user equipment for CHO and/or CPC using SRB3, according to a particular embodiment.

In FIGS. 10 and 11, the indication from the UE to the MN described above is referred to as “CHO release indication.” In some embodiments, not all illustrated steps may be required, for example the indication in the SN Mod Required.

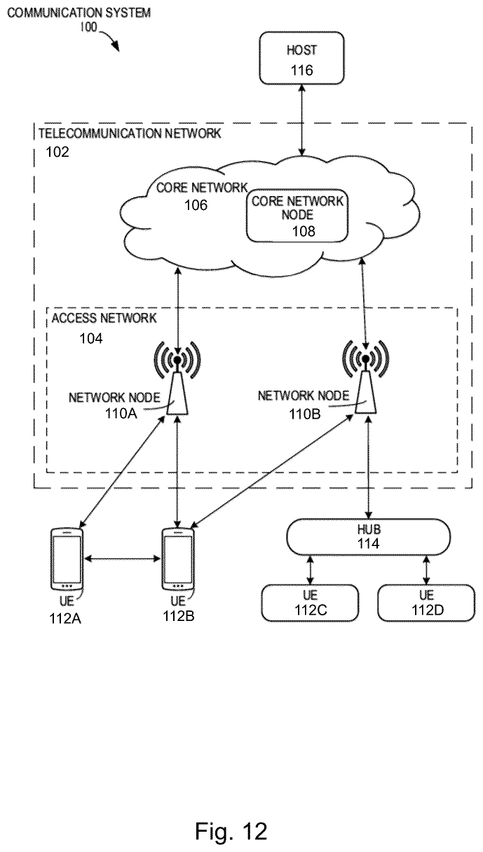

FIG. 12 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

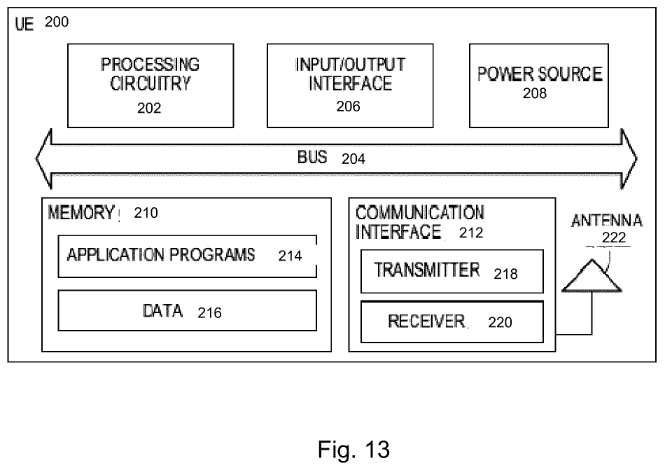

FIG. 13 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

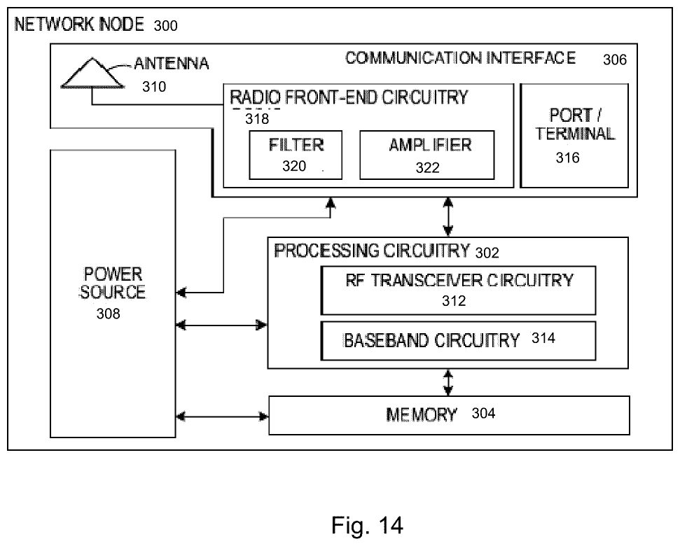

FIG. 14 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 14 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

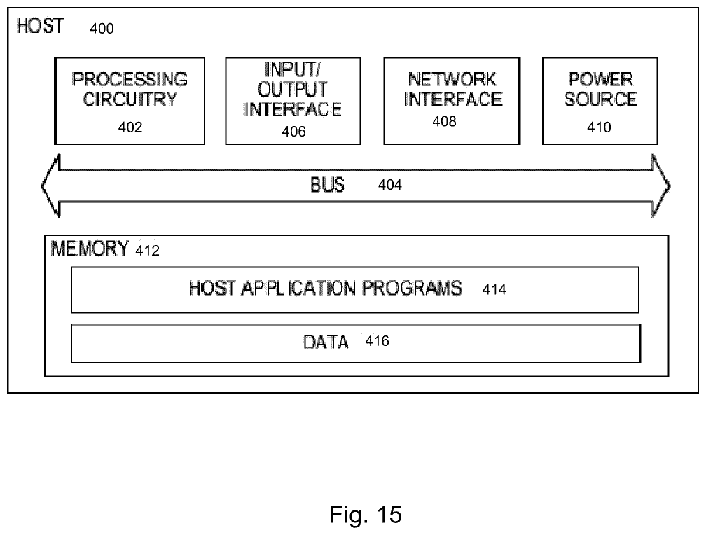

FIG. 15 is a block diagram of a host 400, which may be an embodiment of the host 116 of FIG. 12, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

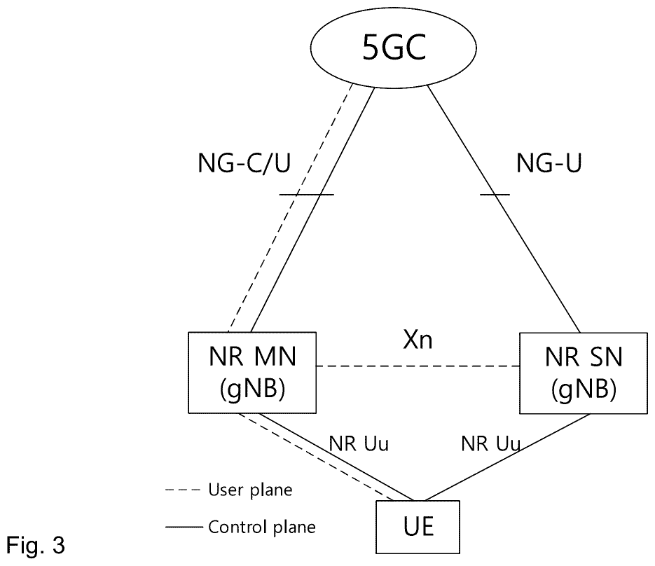

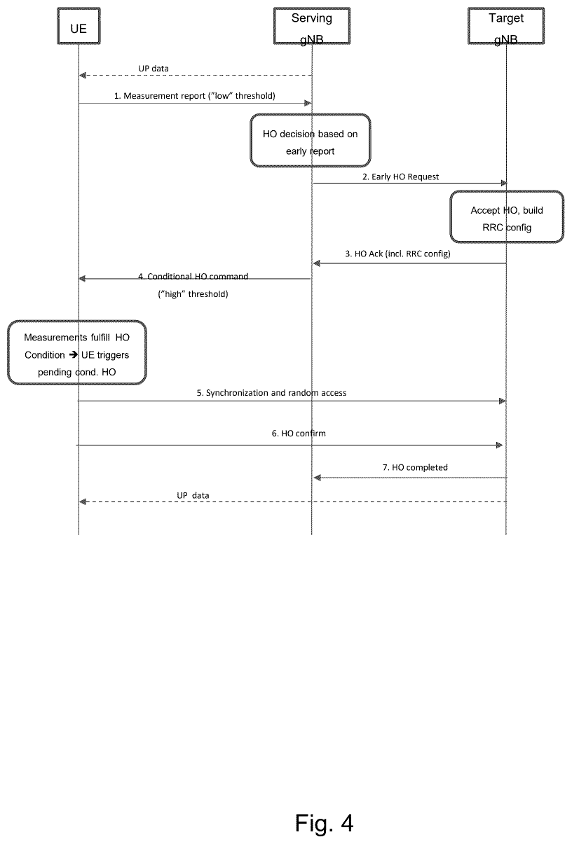

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 3 and 4, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

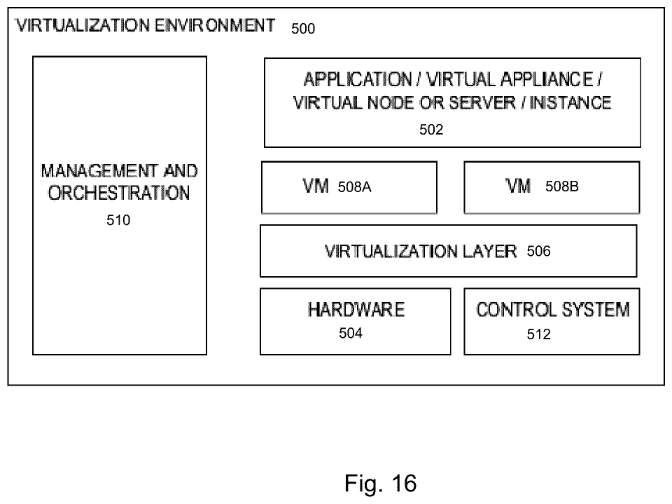

FIG. 16 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

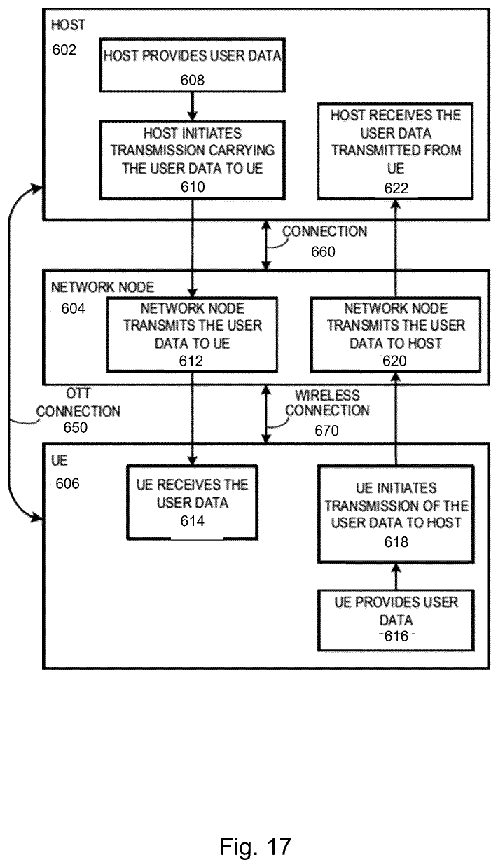

FIG. 17 shows a communication diagram of a host 602 communicating via a network node 604 with a UE 606 over a partially wireless connection in accordance with some embodiments. Example implementations, in accordance with various embodiments, of the UE (such as a UE 112a of FIG. 12 and/or UE 200 of FIG. 13), network node (such as network node 110a of FIG. 12 and/or network node 300 of FIG. 14), and host (such as host 116 of FIG. 12 and/or host 400 of FIG. 15) discussed in the preceding paragraphs will now be described with reference to FIG. 17.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 12) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the delay to directly activate an SCell by RRC and power consumption of user equipment and thereby provide benefits such as reduced user waiting time and extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

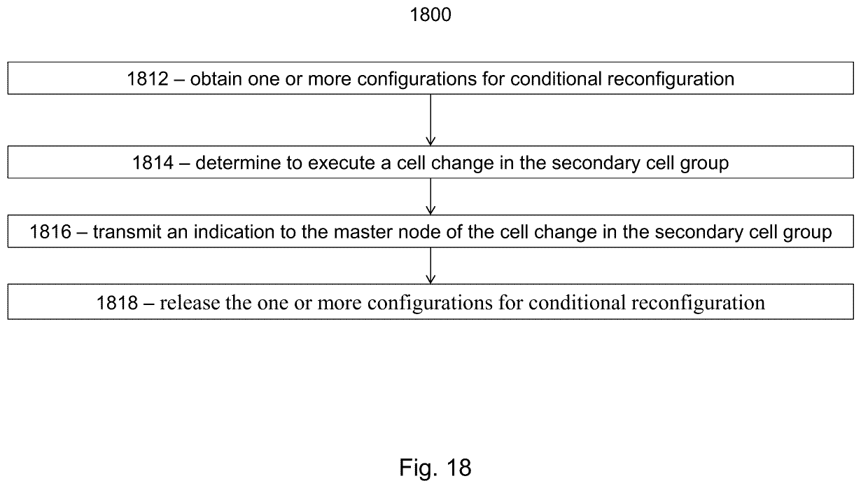

FIG. 18 is a flowchart illustrating an example method in a wireless device, according to certain embodiments. In particular embodiments, one or more steps of FIG. 18 may be performed by UE 200 described with respect to FIG. 13. The wireless device operating in dual connectivity with a master node in a master cell group and a secondary node in a secondary cell group.

The method begins at step 1812, where the wireless device (e.g., UE 200) obtains one or more configurations for conditional reconfiguration. For example, the wireless device may obtain one or more configurations for at least one of conditional handover (CHO), conditional PSCell change (CPC), and conditional PSCell addition (CPA). The wireless device may obtain the configurations from a network node.

At step 1814, the wireless device determines to execute a cell change in the secondary cell group (e.g., the cell change comprises a PSCell change).

At step 1816, the wireless device transmits an indication to the master node of the cell change in the secondary cell group. The indication lets the master node know that the wireless device will be releasing configurations for conditional reconfiguration so that the master node can take appropriate action, as described above.

The indication may comprise a RRC message, such as an ULInformationTransferMRDC message.

At step 1818, the wireless device releases the one or more configurations for conditional reconfiguration.

In some embodiments, in response to transmitting the indication to the master node of the cell change in the secondary cell group, at step 1820 the wireless device receives one or more configurations for conditional reconfiguration. For example, in response to the indication transmitted at step 1816, the master node may determine the wireless device needs an updated configuration for conditional reconfiguration to replace/modify/update the configurations released in step 1818.

Modifications, additions, or omissions may be made to method 1800 of FIG. 18. Additionally, one or more steps in the method of FIG. 18 may be performed in parallel or in any suitable order.

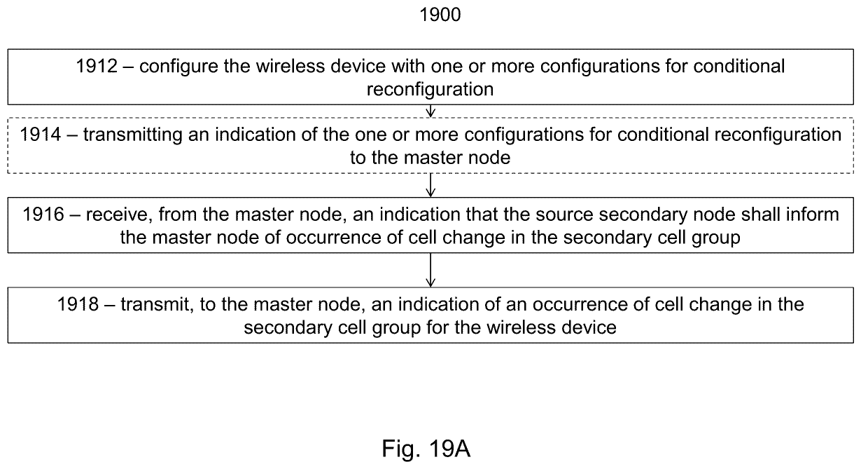

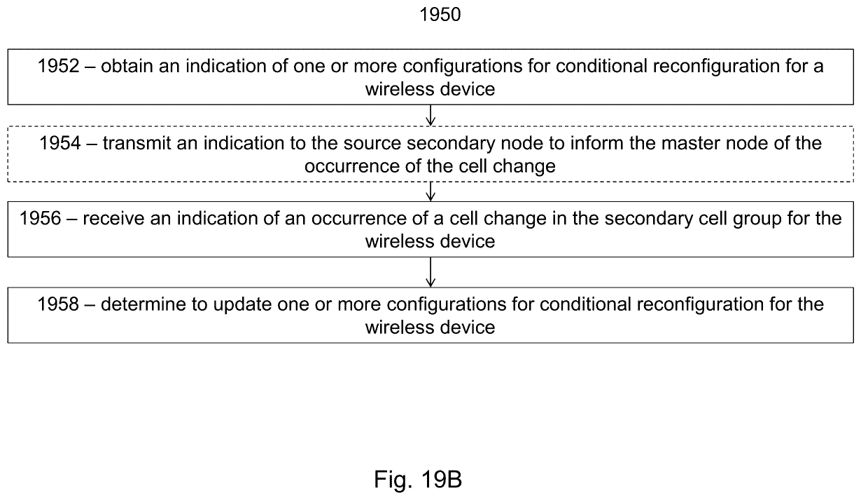

FIG. 19A is a flowchart illustrating an example method in a network node in a SCG, according to certain embodiments. In particular embodiments, one or more steps of FIG. 19A may be performed by network node 300 described with respect to FIG. 14. The network node is operating as a source secondary node in a SCG for a wireless device operating in dual connectivity with a master node in a MCG.

The method begins at step 1912, where the network node (e.g., network node 300) configures the wireless device with one or more configurations for conditional reconfiguration. In particular embodiments, the one or more configurations for conditional reconfiguration comprise one or more configurations for at least one of a CHO, a CPC, and a CPA. The configurations may be obtained according to any of the embodiments and examples described herein.

At step 1914, the network node may transmit an indication of the one or more configurations for conditional reconfiguration to the master node. The indication may comprise a number of conditional reconfigurations configured for the wireless device.

At step 1916, the network node receives, from the master node, an indication that the source secondary node shall inform the master node of occurrence of cell change in the secondary cell group.

In some embodiments, one or both of steps 1912 and 1914 are not necessary and the network node may autonomously perform the next steps.

At step 1918, the network node transmits, to the master node, an indication of an occurrence of cell change in the secondary cell group for the wireless device. In particular embodiments, transmitting the indication of the occurrence of the cell change for the wireless device to the master node comprises transmitting an XnAP message (e.g., XN_U ADDRESS INDICATION) to the master node.

Modifications, additions, or omissions may be made to method 1900 of FIG. 19A. Additionally, one or more steps in the method of FIG. 19A may be performed in parallel or in any suitable order.

Modifications, additions, or omissions may be made to the methods disclosed herein without departing from the scope of the invention. The methods may include more, fewer, or other steps. Additionally, steps may be performed in any suitable order.

FIG. 19B is a flowchart illustrating an example method in a network node in a MCG, according to certain embodiments. In particular embodiments, one or more steps of FIG. 19B may be performed by network node 300 described with respect to FIG. 14. The network node is operating as a master node in a master cell group for a wireless device operating in dual connectivity with a source secondary node in a secondary cell group.

The method begins at step 1952, where the network node (e.g., network node 300) obtains an indication of one or more configurations for conditional reconfiguration for the wireless device. In particular embodiments, obtaining the indication of the one or more configurations for conditional reconfiguration comprises receiving the indication from the source secondary node. The indication of the one or more configurations for conditional reconfiguration may comprise a number of conditional reconfigurations configured for the wireless device. The one or more configurations for conditional reconfiguration comprise one or more configurations for at least one of a CHO, a CPC, and a CPA.

At step 1954, the network node may transmit a request to the source secondary node to inform the master node of the occurrence of the cell change. In some embodiments, this step is unnecessary and the source secondary node autonomously informs the network node of the occurrence of the cell change.

At step 1956, the network node receives an indication of an occurrence of a cell change in the secondary cell group (e.g., PSCell change) for the wireless device. In particular embodiments, the indication of the occurrence of the cell change in the secondary cell group for the wireless device is received from one of the source secondary node and the wireless device. In particular embodiments, receiving the indication of the occurrence of the cell change in the secondary cell group for the wireless device comprises receiving an XnAP message (e.g., XN_U ADDRESS INDICATION) from the source secondary node.

Based on the indication of the occurrence of the cell change in the secondary cell group for the wireless device, at step 1958 the network node determines to update one or more configurations for conditional reconfiguration for the wireless device. For example, the network node knows the wireless device has released its configurations for conditional reconfiguration and can determine if any configurations need to be restored, new configurations created, or that no configurations are needed.

Modifications, additions, or omissions may be made to method 1950 of FIG. 19B. Additionally, one or more steps in the method of FIG. 19B may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments are described below.

### Group A Embodiments

1. A method performed by a wireless device operating in dual connectivity with a master node and a secondary node, the method comprising:
   transmitting an indication to the mater node that the wireless device has executed a conditional cell change; and
   releasing one or more configurations for conditional reconfiguration.
2. The method of the previous embodiment, wherein the indication comprises a radio resource control (RRC) message.
3. The method of the previous embodiment, wherein the RRC message comprises an ULInformationTransferMRDC message.
4. The method of any one of the previous embodiments, wherein the conditional cell change comprises a conditional PSCell change (CPC).
5. A method performed by a wireless device, the method comprising:
   any of the wireless device steps, features, or functions described above, either alone or in combination with other steps, features, or functions described above.
6. The method of the previous embodiment, further comprising one or more additional wireless device steps, features or functions described above.
7. The method of any of the previous embodiments, further comprising:
   providing user data; and
   forwarding the user data to a host computer via the transmission to the base station.

### Group B Embodiments

8. A method performed by a base station capable of operating as a dual connectivity source secondary node, the method comprising:
   obtaining one or more configurations for conditional reconfiguration for a wireless device;
   transmitting an indication of the one or more configurations for conditional reconfiguration to a dual connectivity master node; and
   transmitting an indication to the master node that a reconfiguration has occurred.
9. The method of the previous embodiment, further comprising receiving a request from the master node to inform the master node when a reconfiguration occurs.
10. The method of any one of embodiments 8-9, wherein the indication of the one or more configurations for conditional reconfiguration comprises a number of conditional reconfigurations that will be configured for the wireless device.
11. A method performed by a base station capable of operating as a dual connectivity master node, the method comprising:
   receiving an indication of one or more configurations for conditional reconfiguration for a wireless device; and
   receiving an indication that a reconfiguration has occurred.
12. The method of the previous embodiment, further comprising transmitting a request to a dual connectivity source secondary node to inform the base station when a reconfiguration occurs.
13. The method of any one of embodiments 10-11, wherein the indication of the one or more configurations for conditional reconfiguration comprises a number of conditional reconfigurations that will be configured for the wireless device.
14. The method of any one of embodiments 10-14, wherein the indication that the reconfiguration has occurred is received from one of a source secondary node and a wireless device.
15. A method performed by a base station, the method comprising:
   any of the steps, features, or functions described above with respect to base station, either alone or in combination with other steps, features, or functions described above.
16. The method of the previous embodiment, further comprising one or more additional base station steps, features or functions described above.
17. The method of any of the previous embodiments, further comprising:
   obtaining user data; and
   forwarding the user data to a host computer or a wireless device.

### Group C Embodiments

18. A mobile terminal comprising:
   processing circuitry configured to perform any of the steps of any of the Group A embodiments; and
   power supply circuitry configured to supply power to the wireless device.
19. A base station comprising:
   processing circuitry configured to perform any of the steps of any of the Group B embodiments;
   power supply circuitry configured to supply power to the wireless device.
20. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
21. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
22. The communication system of the pervious embodiment further including the base station.
23. The communication system of the previous 2 embodiments, further including the UE, wherein the UE is configured to communicate with the base station.
24. The communication system of the previous 3 embodiments, wherein:
   the processing circuitry of the host computer is configured to execute a host application, thereby providing the user data; and
   the UE comprises processing circuitry configured to execute a client application associated with the host application.
25. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
26. The method of the previous embodiment, further comprising, at the base station, transmitting the user data.
27. The method of the previous 2 embodiments, wherein the user data is provided at the host computer by executing a host application, the method further comprising, at the UE, executing a client application associated with the host application.
28. A user equipment (UE) configured to communicate with a base station, the UE comprising a radio interface and processing circuitry configured to performs any of the previous 3 embodiments.
29. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
30. The communication system of the previous embodiment, wherein the cellular network further includes a base station configured to communicate with the UE.
31. The communication system of the previous 2 embodiments, wherein:
   the processing circuitry of the host computer is configured to execute a host application, thereby providing the user data; and
   the UE's processing circuitry is configured to execute a client application associated with the host application.
32. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
33. The method of the previous embodiment, further comprising at the UE, receiving the user data from the base station.
34. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
35. The communication system of the previous embodiment, further including the UE.
36. The communication system of the previous 2 embodiments, further including the base station, wherein the base station comprises a radio interface configured to communicate with the UE and a communication interface configured to forward to the host computer the user data carried by a transmission from the UE to the base station.
37. The communication system of the previous 3 embodiments, wherein:
   the processing circuitry of the host computer is configured to execute a host application; and
   the UE's processing circuitry is configured to execute a client application associated with the host application, thereby providing the user data.
38. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
39. A method implemented in a communication system including a host computer, a base station and a user equipment (UE), the method comprising:
   at the host computer, receiving user data transmitted to the base station from the UE, wherein the UE performs any of the steps of any of the Group A embodiments.
40. The method of the previous embodiment, further comprising, at the UE, providing the user data to the base station.
41. The method of the previous 2 embodiments, further comprising:
   at the UE, executing a client application, thereby providing the user data to be transmitted; and
   at the host computer, executing a host application associated with the client application.
42. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
43. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
44. The communication system of the previous embodiment further including the base station.
45. The communication system of the previous 2 embodiments, further including the UE, wherein the UE is configured to communicate with the base station.
46. The communication system of the previous 3 embodiments, wherein:
   the processing circuitry of the host computer is configured to execute a host application;
   the UE is configured to execute a client application associated with the host application, thereby providing the user data to be received by the host computer.
47. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
48. The method of the previous embodiment, further comprising at the base station, receiving the user data from the UE.
49. The method of the previous 2 embodiments, further comprising at the base station, initiating a transmission of the received user data to the host computer.

1. A method performed by a network node capable of operating as a source secondary node in a secondary cell group (SCG) for a wireless device operating in dual connectivity with a master node in a master cell group (MCG), the method comprising:
configuring the wireless device with one or more configurations for conditional reconfiguration;
receiving, from the master node, an indication that the source secondary node shall inform the master node of occurrence of cell change in the secondary cell group; and
transmitting, to the master node, an indication of an occurrence of cell change in the secondary cell group for the wireless device.

2. The method of claim 1, further comprising transmitting an indication of the one or more configurations for conditional reconfiguration to the master node.

3. The method of claim 2, wherein the indication of the one or more configurations for conditional reconfiguration comprises a number of conditional reconfigurations configured for the wireless device.

4. The method of claim 1, wherein the one or more configurations for conditional reconfiguration comprise one or more configurations for at least one of a conditional handover (CHO), a conditional primary SCG cell (PSCell) change (CPC), and a conditional PSCell addition (CPA).

5. The method of claim 1, wherein the cell change comprises a primary SCG cell (PSCell) change.

6. The method of claim 1, wherein transmitting the indication of the occurrence of the cell change for the wireless device to the master node comprises transmitting an XnAP message to the master node.

7. A network node capable of operating as a source secondary node in a secondary cell group (SCG) for a wireless device operating in dual connectivity with a master node in a master cell group (MCG), the network node comprising processing circuitry operable to:
configure the wireless device with one or more configurations for conditional reconfiguration;
receive, from the master node, an indication that the source secondary node shall inform the master node of occurrence of cell change in the secondary cell group; and
transmit, to the master node, an indication of an occurrence of cell change in the secondary cell group for the wireless device.

8. The network node of claim 7, the processing circuitry further operable to transmit an indication of the one or more configurations for conditional reconfiguration to the master node.

9. (canceled)

10. (canceled)

11. A method performed by a network node capable of operating as a master node in a master cell group for a wireless device operating in dual connectivity with a source secondary node in a secondary cell group, the method comprising:
obtaining an indication of one or more configurations for conditional reconfiguration for the wireless device;
transmitting an indication to the source secondary node to inform the master node of the occurrence of the cell change;
receiving an indication of an occurrence of a cell change in the secondary cell group for the wireless device; and
based on the indication of the occurrence of the cell change in the secondary cell group for the wireless device, determining to update one or more configurations for conditional reconfiguration for the wireless device.

12. The method of claim 11, wherein obtaining the indication of the one or more configurations for conditional reconfiguration comprises receiving the indication from the source secondary node.

13. The method of claim 12, wherein the indication of the one or more configurations for conditional reconfiguration comprises a number of conditional reconfigurations configured for the wireless device.

14. The method of claim 11, wherein the one or more configurations for conditional reconfiguration comprise one or more configurations for at least one of a conditional handover (CHO), a conditional primary SCG cell (PSCell) change (CPC), and a conditional PSCell addition (CPA).

15. The method of claim 11, wherein the indication of the occurrence of the cell change in the secondary cell group for the wireless device is received from one of the source secondary node and the wireless device.

16. The method of claim 11, wherein the cell change comprises a primary SCG cell (PSCell) change.

17. The method of claim 11, wherein receiving the indication of the occurrence of the cell change in the secondary cell group for the wireless device comprises receiving an XnAP message from the source secondary node.

18. A network node capable of operating as a master node in a master cell group for a wireless device operating in dual connectivity with a secondary node in a secondary cell group, the network node comprising processing circuitry operable to:
obtain an indication of one or more configurations for conditional reconfiguration for the wireless device;
transmit an indication to the source secondary node to inform the master node of the occurrence of the cell change;
receive an indication of an occurrence of a cell change in the secondary cell group for the wireless device; and
based on the indication of the occurrence of the cell change in the secondary cell group for the wireless device, determine to update one or more configurations for conditional reconfiguration for the wireless device.

19. The network node of claim 18, wherein processing circuitry operable to obtain the indication of the one or more configurations for conditional reconfiguration comprises processing circuitry operable to receive the indication from the source secondary node.

20. (canceled)

21. (canceled)
